(19) United States
(12) Patent Application Publication
(10) Pub. No.: US 2007/0109574 A1
(43) Pub. Date: May 17, 2007

(54) System and method for assembly of multiple format digital files

(75) Inventor: Andrey Savov, Fullerton, CA (US)

Correspondence Address: TUCKER, ELLIS & WEST LLP, 1150 HUNTINGTON BUILDING, 925 EUCLID AVENUE, CLEVELAND, OH, 44115-1414, US

(73) Assignees: Kabushiki Kaisha Toshiba; Toshiba Tec Kabushiki Kaisha

(21) Appl. No.: 11/272,852

(22) Filed: Nov. 14, 2005

(51) Int. Cl. G06F 3/12

(52) U.S. Cl. 358/1.13; 358/1.15

(57) ABSTRACT

A system and method for the assembly of multiple format digital files. A user is prompted to select an original file for further processing, whereupon the file is converted, when required, into a digital format. The user then selects the desired output formats corresponding to the files received in the file processing request associated with the original input file. When processing of each output is the same, the outputs are first converted into the desired output format and the user selects one or more basic operations or previously stored tasks to be performed in the processing of the output sets to form a new task. When each output requires different processing, the outputs are first converted into the desired output format and the user selects one or more basic operations or tasks for each output set to form multiple new tasks. The selected operations or tasks are then executed by the digital multifunction device and the newly generated task or tasks are stored for further use.

### BACKGROUND OF THE INVENTION

This invention is directed to a system and method for the assembly of multiple format digital files. More particularly, this invention is directed to a system and method which separates basic operations of digital multifunctional devices into elemental functions and allows the functions to be combined into more complex operations or functions. In one embodiment of the present invention, at least one digital input is output to a plurality of distinct output formats or destinations. In another embodiment, a plurality of distinct input files are received, converted to a selected output format, and routed to a plurality of distinct output devices.

Digital multifunctional devices typically comprise a plurality of common functions or operations, such as scanning capability, printing capability, facsimile capability, voice recording and reproduction capability, and digital storage capability. The digital multifunction device will generally be configured by the manufacturer or system administrator for the most common or requested functions needed by users. However, there are some situation wherein a user would require more complex functions than those as configured. Further, some users may perform repetitive cycles of complex functions or operations. These complex operations often change very little or not all between subsequent performance of these operations. For example, a user may require that all facsimiles received from a certain source be converted to one file format and stored in a storage medium and also be scanned and converted to another file format. The user must repeat each step for each facsimile received, which can be time consuming and prone to error. Therefore, there is a need for a system and method which separates basic operations of digital multifunctional devices into elemental functions and allows the functions to be combined into more complex operations or functions.

The subject invention overcomes the afore-noted problems and provides a system and method for the assembly of multiple format digital files.

### SUMMARY OF THE PRESENT INVENTION

In accordance with the present invention, there is provided a system and method which separates basic operations of digital multifunctional devices into elemental functions and allows the functions to be combined into more complex operations or functions.

Further, in accordance with the present invention, there is provided a system and method for the assembly of multiple format digital files.

Further, in accordance with the present invention, there is provided a system and method for assembly of multiple format digital files wherein at least one digital input is output to a plurality of distinct output formats or destinations.

Still further, in accordance with the present invention, there is provided a system and method for assembly of multiple format digital files wherein a plurality of distinct input files are received, converted to a selected output format, and routed to a plurality of distinct output devices.

In one embodiment of the present invention, there is provided a system for the assembly of multiple format digital files which comprises means adapted for selecting at least one digital input from a plurality thereof and means adapted for receiving data representative of a plurality of selected output formats for the at least one digital input. The system further comprises conversion means adapted for converting the at least one digital input into each of the plurality of selected output formats and output means adapted for outputting each converted digital input to an associated document output device.

In accordance with the present invention, there is also provided a method for the assembly of multiple format digital files. The method comprises the steps of selecting at least one digital input from a plurality thereof and receiving data representative of a plurality of selected output formats for the at least one digital input. The method further comprises the steps of converting the at least one digital input into each of the plurality of selected output formats and outputting each converted digital input to an associated document output device.

In another embodiment, there is provided a system for the assembly of multiple format digital files. The system comprises receiving means adapted for receiving input data representative of a first digital file in a first file format and the receiving means further including means adapted for receiving input data representative of at least one second digital file in a file format distinct from the first file format. The system also comprises conversion means adapted for converting each received digital file into at least one of a plurality of selected output formats and output means adapted for outputting each converted digital file to an associated document output device.

In accordance with the invention, there is further provided a method for the assembly of multiple format digital files which comprises the steps of receiving input data representative of a first digital file in a first file format and receiving input data representative of at least one second digital file in a file format distinct from the first file format. The method further comprises the steps of converting each received digital file into at least one of a plurality of selected output formats and output means adapted for outputting each converted digital file to an associated document output device.

Still other objects and aspects of the present invention will become readily apparent to those skilled in this art from the following description wherein there is shown and described a preferred embodiment of this invention, simply by way of illustration of one of the best modes suited for to carry out the invention. As it will be realized, the invention is capable of other different embodiments and its several details are capable of modifications in various obvious aspects all without from the invention. Accordingly, the drawing and descriptions will be regarded as illustrative in nature and not as restrictive.

### BRIEF DESCRIPTION OF THE DRAWINGS

The accompanying drawings incorporated in and forming a part of the specification, illustrate several aspects of the present invention, and together with the description serve to explain the principles of the invention. In the drawings:

FIG. 1 is a block diagram of the system according to the present invention;

FIG. 2 is a flowchart illustrating a method for assembling multiple format digital files according to the present invention; and

FIG. 3 is a flowchart illustrating a method for selecting processing options according to the present invention.

### DETAILED DESCRIPTION OF THE PREFERRED EMBODIMENT

This invention is directed to a system and method for a system and method for the assembly of multiple format digital files. This invention separates basic operations of digital multifunctional devices into elemental functions and allows the functions to be combined into more complex operations or functions. In one embodiment of the present invention, at least one digital input is output to a plurality of distinct output formats or destinations. In another embodiment, a plurality of distinct input files are received, converted to a selected output format, and routed to a plurality of distinct output devices. In the preferred embodiment, as described herein, the digital multifunctional device is suitably capable of providing scanning, copying, facsimile, digital sound processing, printing, file management, file storage, electronic mail, digital photography, digital video editing, and other functions to a user.

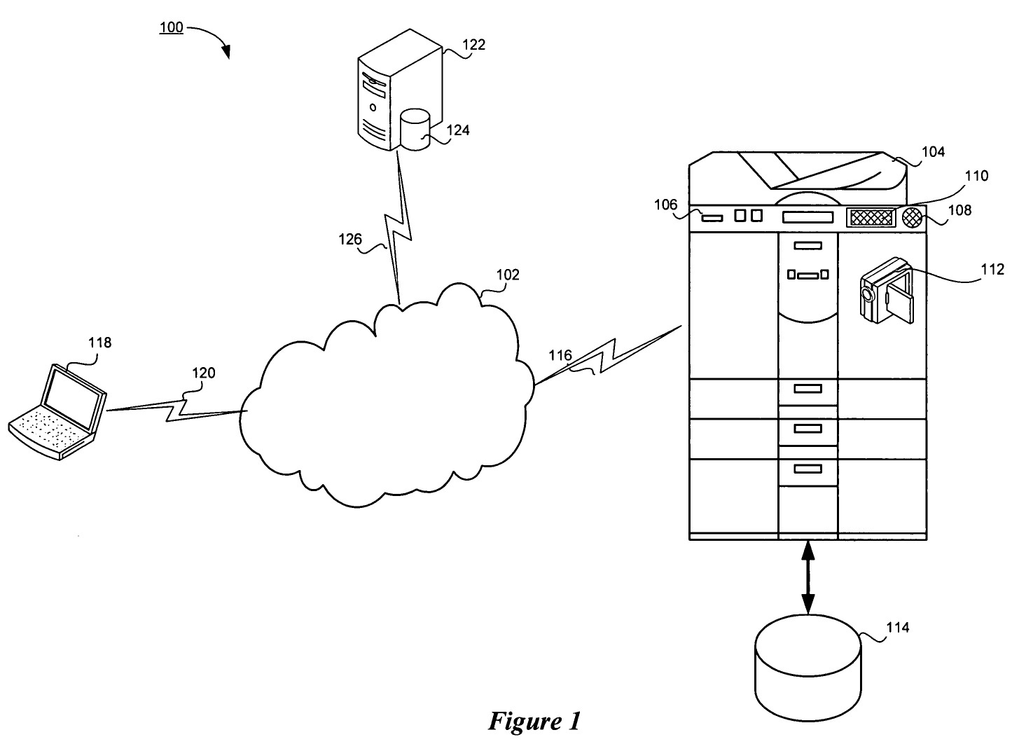

Turning now to FIG. 1, there is shown a block diagram illustrating a system 100 in accordance with the present invention. As shown in FIG. 1, the system includes a distributed computing environment, illustrated in FIG. 1 as a computer network 102. It will be understood by those skilled in the art that the computer network 102 is any computing environment known in the art capable of facilitating the exchange of data between two or more electronic devices. The skilled artisan will appreciate that the computer network 102 is capable of implementation via the public-switched telephone network, an Ethernet based wired or wireless network, the Internet, an Intranet, a local area network, a wide area network, a personal area network, or any combination thereof. In the preferred embodiment, the computer network 102 is suitably adapted to enable the two-way exchange of data between electronic devices connected thereto. In one particular embodiment, the computer network 102 is a local area network, employing one or more security features, such as unique password/username combinations, thereby restricting access to the network 102. Further in accordance with the present invention, the computer network 102 is accessible via a wide area network, such as the Internet, whereby authenticated remote users are able to access the resources contained on the computer network 102.

The system 100 further includes at least one digital multifunction device 104, communicatively coupled to the computer network via the communications link 116. Preferably, the digital multifunction device 104 is suitably capable of sending and receiving data communications, inclusive of audio, video, text, image, and the like, via the communications link 116. As depicted in FIG. 1, the digital multifunction device 104 is a multifunction peripheral device, suitably adapted to provide a variety of processing services, such as, for example and without limitation, scanning, digital image processing, copying, facsimile, audio processing, printing, storage, text recognition, audio recognition, and the like. Suitable commercially available digital multifunction devices include, but are not limited to, the Toshiba e-Studio Series Controller. In one embodiment, the digital multifunction device 104 is suitably equipped to receive a plurality of portable storage media, including without limitation, Firewire drives, USB drives, SD, MMC, XD, Compact Flash, Memory Stick, and the like. In the preferred embodiment, the digital multifunction device 104 is further equipped to communicate with a variety of networked devices, for example and without limitation, networked storage devices, network servers, user devices, and the like. The extent of which communication is discussed in greater detail below. To facilitate the communication between the digital multifunction device 104 and the computer network 102, the communications link 116 is advantageously employed. In accordance with the present invention, the communications link 116 is any suitable channel of data communications known in the art including, but not limited to wireless communications, for example and without limitation, Bluetooth, WiMax, 802.11a, 802.11b, 802.11g, 802.11(x), infrared, optical, or any suitable wireless data transmission system, or wired communications, including, without limitation, telephonic wire, coaxial cable, Ethernet cable, and the like, as are known in the art.

The digital multifunction device 104, further in accordance with the present invention, includes an associated user interface 106, communicatively coupled thereto. The user interface 106 is any suitable means of communicating with a user known in the art, including, without limitation, an LCD, a touch-screen, an alphanumeric keyboard, cathode ray tube, function specific tactile input device, and the like. Preferably, the user interface 106 of the digital multifunction device 104 uses a touch-screen interface, suitably capable of displaying and receiving user selections. In accordance with one aspect of the present invention, the user interface 106 also includes a microphone 108, suitably adapted to receive audio input from an associated user, such as voice messages, telephonic conversations, and the like. The user interface 106 further includes at least one speaker 110, suitably adapted to output audio files, signals, and the like, so as to enable the user to hear such audio files, signals, and the like. In addition to the foregoing, the user interface 106 includes a digital camera component 112, suitably adapted to capture video and still images and convert the same into digital media files, capable of further processing by the digital multifunction device. It will be understood by those skilled in the art that in accordance with the present invention, the user interface 106 is advantageously capable of providing dynamic information to the user of the digital multifunction device 104. The digital multifunction device 104 further includes an associated data storage 114, communicatively coupled thereto. Preferably, the data storage 114 is any suitable means of storing data known in the art. Suitable data storage 114 includes, but is not limited to, magnetic hard disk drives, flash memory, optical storage, or any combination thereof.

In one embodiment of the present invention, the system 100 is further capable of including, but is not limited to, at least one user device 118, illustrated in FIG. 1 as a notebook computer. The skilled artisan will appreciate that any suitable user device known in the art, capable of interacting with the computer network 102 and the digital multifunction device 104, is equally capable of being implemented in accordance with the present invention. Suitable user devices include, but are not limited to, desktop computers, personal data assistants, digital cameras, digital video recorders, cellular-enabled wireless devices, web-enabled cellular telephones, audio recorders, tablet computers, and the like. In addition, the skilled artisan will understand that the subject invention is capable of operating without the user device 118, whereupon the user interacts directly with the digital multifunction device 104 via the associated user interface 106. In the present embodiment, the user device 118 is advantageously in data communication with the computer network 102 via a communications link 120. It will be appreciated by those skilled in the art that the communications link 120 is any suitable communications channel, known in the art, capable of facilitating the exchange of data communications between two or more electronic devices. The user device 118 is further equipped to request file processing operations on the digital multifunction device 104 via the computer network 102.

The system 100 further includes a file server 122 communicatively coupled to the computer network 102 via the communications link 126. It will be understood by those skilled in the art that the file server 122 is any computing device, software, or combination thereof, known in the art capable of providing a structured repository of document files, video files, audio files, image files, and the like. In the preferred embodiment, the file server 122 includes an associated data storage 124, suitably adapted to store document files, video files, image files, audio files, and the like. It will be understood by the skilled artisan that the file server 122 is suitably adapted to receive and store files in a variety of formats, including without limitation, portable document formats, document formats, TIFF, JPEG, WPD, DOC, TXT, HTML, XML, RTF, and the like. As will be understood by those skilled in the art, the data storage 124 is any mass storage device known in the art, including, without limitation, magnetic hard disk drives, flash memory, optical storage, or any combination thereof. Preferably, the data storage 124 includes data representative of one or more electronic documents. Although not shown in FIG. 1, the skilred artisan will appreciate that the file server 122 is advantageously equipped with a user-interface, thereby enabling a direct interface with the server 122. Furthermore, the skilled artisan will appreciate that a user is also able to directly interface with the server 122 using a suitable electronic device such as the user device 118, the digital multifunction device 104, and the like, via the computer network 102.

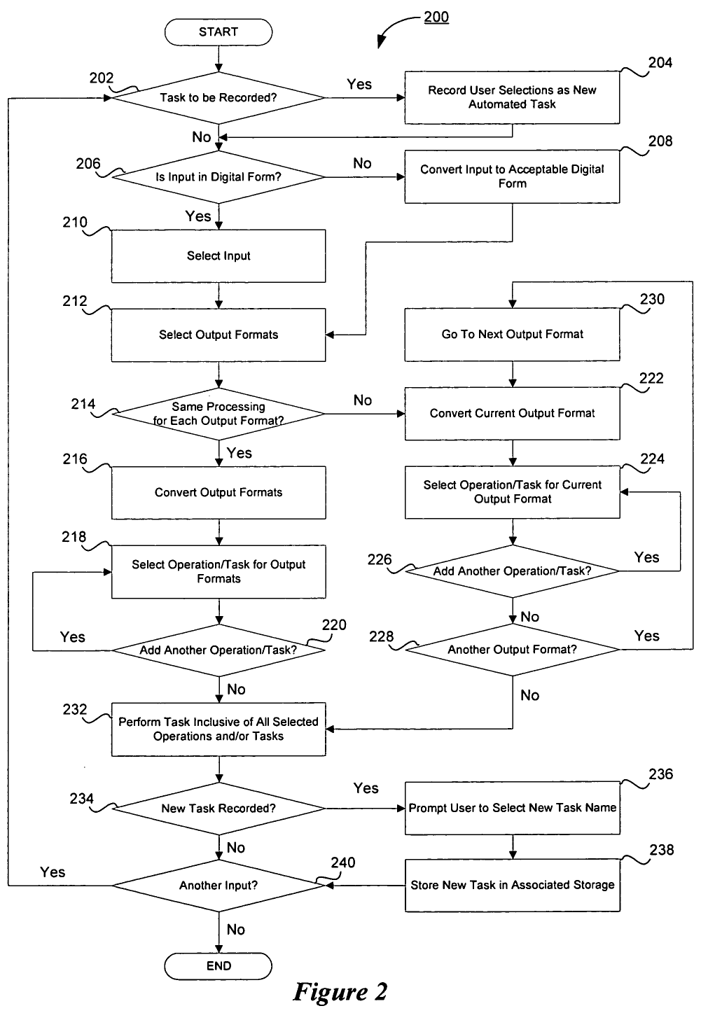

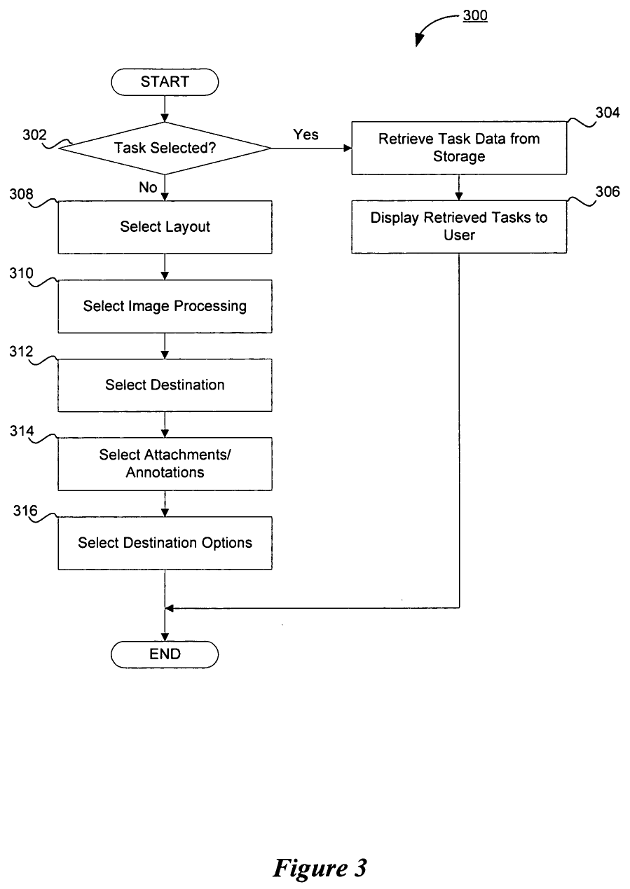

The skilled artisan will appreciate that the digital multifunction device 104 of the present invention is suitably capable of performing a variety of tasks, with each task consisting of one or more basic operations, such as, for example and without limitation, scanning a hardcopy, printing, facsimile operations, video operations, file conversions, voice operations, storage operations and the like. The skilled artisan will further appreciate that each task suitably instructs the digital multifunction device in a course of operations to be performed on a one or more digital files. Preferably, each task is further capable of being stored in the associated data storage 114, communicatively coupled to the digital multifunction device 104, thereby enabling a user to reuse the same task on a different file or files, or the same file or files, at any point in future. The process by which a task is generated and used will be discussed in greater detail below, with respect to FIGS. 2 and 3.

The basic scan operation contemplated in accordance with the present invention includes the generation of a digital image representation of an original paper document. The basic print operation, as will be appreciated by those skilled in the art, includes the transfer of digital representations of documents, images, and the like, and outputting thereof onto an output medium, wherein such operation also includes finishing options, as will be understood by the skilled artisan. The basic conversion operation, in accordance with the present invention, suitably includes the conversion of a digital file from one format into a different file format. In addition, the basic facsimile operation, in accordance with the present invention, comprises the transmission and/or receipt of digital raster renderings of documents, images, and the like, via the public-switched telephone network, the Internet, or the like. The basic video operation contemplated by the present invention includes the digital capture of images from a video file, video file manipulation and editing, and the like. The basic voice operation contemplated by the present invention includes the digital recodation and playback of sound waves, and the basic storage operation of the instant invention includes the storage of digital representations of images, documents, sound recordings, and the like, on an associated storage device 114, a remote storage server 122, or any combination thereof.

In operation, a user, either via the user device 118, or directly via the user interface 106, suitably selects or creates a task, corresponding to a file processing request. The file processing request includes, but is not limited to, processing by the digital multifunction device 104 of a text file, image file, video file, sound recording, and the like. The user is first prompted by the digital multifunction device 104 to determine whether or not to save the new task into the associated storage 114, whereby the task will be available for later use. Preferably, the user is prompted via the user interface 106, however the skilled artisan will appreciate that the user is able to create a task via the user device 118 using a suitable web browser, application, or any combination thereof. When storage is selected by the user, each operation/function that is selected by the user is recorded by the digital multifunction device 104. The digital multifunction device 104 then determines whether the original, or input, i.e., the document, image, video, voice recording, and the like, is available in digital format, or if the input exists in its pre-digital form, i.e., photograph, sheets of paper, tape recorder, video tape, and the like. When the original is not present in digital form, the original is converted to a digital format, suitable for further processing by the digital multifunction device 104. For example, when the original is a paper document, the sheets of paper comprising the original document are scanned into a suitable file format. The skilled artisan will appreciate that the digital multifunction device 104 is suitably capable of performing a variety of conversions as needed by the user. When the original document is available in digital form, the user is prompted to select, via the user interface 106, or a suitable interface on the user device 118, an input for further processing in accordance with the to be selected operations. It will be appreciated by those skilled in the art that the selection of an original in digital format is capable of being accomplished by retrieving such an original from the local storage device associated with the user device 118, from the digital multifunction device associated storage 114, from the file server 122 storage 124, from an attachment to an electronic mail message, or any combination thereof.

Next, the user selects the desired output formats associated with the selected input, that is, the user selects the format for each output desired with respect to the original input. Thus, for example and without limitation, when the digital multifunction device 104 receives an electronic mail message containing a plurality of attached digital files, with each file in a different file format, i.e., one file in TXT, one file in PDF, one file in JPEG, or the like, the digital multifunction device 104 is capable of performing conversions from each of the received formats into different formats, and then processing the different formats in accordance with user provided instructions, such as for example and without limitation, forwarding the converted TXT file to another user, storing the converted PDF file, and printing the converted JPEG file, or any combination thereof. Such a selection is capable of requiring different processing for each output. Alternatively, each output is capable of being processed using the same user selections. When the user selects the same processing for each output, the outputs are converted into the appropriate output formats and the user is prompted to select the first desired basic operation to be performed thereon. The selection of basic operations continues until the user has completed selecting operations to be performed on the input. It will be appreciated by those skilled in the art that the selection of basic operations is further capable of including previously stored tasks, such that a user is able to select a previously created task in the processing of the original, in addition to the basic operations selected. The new task is then performed, resulting in the output of the file processing request by the digital multifunction device 104. When storage has been selected, the user is prompted to select a desired name for the new task, which is then stored by the digital multifunction device 104 on the associated storage 114, for later use.

When the user has selected varied tasks for each output of the original, the user first selects the desired output formats for each output of the original. The user is then prompted to select the basic operations or previously stored tasks for each desired output. Upon completion of task setup for each desired output, the digital multifunction device 104 performs each of the newly created tasks corresponding to the desired outputs. When storage of the newly created tasks was selected by the user, the digital multifunction device 104 prompts the user to select a file name to be associated with each individual task that has been created. The newly created tasks are then stored on the associated storage 114 of the digital multifunction device 104. The operation of the above-described system will be more fully understood in conjunction with the flowcharts of FIGS. 2 and 3, discussed hereinafter.

Referring now to FIG. 2, there is shown a flowchart 200 illustrating the generation and use of a task in accordance with the present invention. Beginning at step 202, a determination is made whether the user desires to make the task to be created available at a future time, i.e., whether or not the user would like to save the task being performed. When the user does desire to save the new task, flow proceeds to step 204, wherein each step in the process being generated is recorded as a new automated task. In accordance with the present invention, the automated task being generated by the method illustrated in FIG. 2 is termed automated in that when a user selects the task at a later point in time, the user need not tediously select each operation again, rather the user need only select the original and the digital multifunction device 104 processes the input in accordance with the automated task retrieved from the associated data storage 114. Whether the user desires to record the task or not, flow proceeds to step 206, whereupon a determination is made as to the format of the original, i.e., whether the original is in an acceptable digital format corresponding to the digital multifunction device 104. When the original is not in an acceptable digital format, flow proceeds to step 208, whereby the original is converted via any suitable means known in the art. Thus, for example and without limitation, when the original is a hard copy of a document, the pages of the document are scanned by the digital multifunction device 104, whereupon a digital image representative of the original document, albeit in digital form, is rendered. In further example, when the original is a voice recording on a digital or analog recording device, the voice recording is transferred to the digital multifunction device 104 via any suitable interfacing means, such as USB, Firewire, playback into the microphone 108, or the like. The digital multifunction device 104 then converts such sound into a digital audio file, which is capable of being further processed in accordance with received user instructions. It will be further appreciated by those skilled in the art that upon the conversion of the original to a digital format at step 208, flow proceeds to step 212, wherein the user selects the desired output formats, as set forth below.

When the original is already in an acceptable digital format, flow proceeds to step 210, wherein the user selects the desired input. It will be appreciated by those skilled in the art that in accordance with a preferred embodiment of the present invention, the user is presented, via the user interface 106, or the user device 118, with a list of available files, such as text files, audio files, image files, video files, and the like, stored on the file server 122, locally to the user device 118, or alternatively the digital multifunction device associated storage 114. Preferably, the user selects an original file from the list of available files for further processing thereof. In either event, flow proceeds from step 210 to step 212, for user selection of the desired output formats. The skilled artisan will appreciate that the term output format is representative of the file format to be associated with the original input. Thus, when the original input comprises multiple digital files, the formats of the multiple digital files, following conversion to the user selected formats, are termed output formats. The conversion of such files is suitably accomplished via the digital multifunction device 104. It will be further appreciated by those skilled in the art that upon the conversion of the original to a digital format at step 208, flow proceeds to step 212, wherein the user selects the desired output formats, as set forth below.

A determination is then made at step 214, following user input of the desired output formats, whether the same processing is to be performed on each output. Thus, as will be understood by those skilled in the art, the user is able to select whether the same processing will be performed on each individual output, or alternatively, whether each individual output will have different processing performed. When each output is to have the same processing, flow proceeds to step 216, whereupon the outputs are converted to the previously selected output formats. Next, at step 218, the user selects the first basic operation or automated task to be performed on the original in order to generate the desired output. It will be appreciated by those skilled in the art that the subject invention is capable of implementing, within a new task, a previously executed and stored task, thereby assisting in the faster selection and output of a processed original. Once the user has selected the desired operation or task, flow proceeds to step 220, wherein a determination is made whether additional operations and/or tasks are to be added to the new task. When additional tasks are to be added, flow returns to step 218, where the user selects the next operation/task to be added to the new task. When no additional tasks remain to be added, flow proceeds to step 232, wherein the digital multifunction device 104 performs the task on the converted outputs.

Returning to step 214, when it is determined that each individual output set will not have the same processing, flow proceeds to step 222, whereupon the first output is converted to the previously selected output format. Flow then proceeds to step 224, wherein the user selects the desired operation or task for the current converted output. Following such selection, flow proceeds to step 226, wherein a determination is made whether additional operations/tasks are to be added to the processing of the current converted output. When the user desires to add more tasks/operations, flow returns to selection step 224. When no additional operations/tasks are to be added to the processing of the current output, flow proceeds to step 228, wherein a determination is made whether any additional outputs remain to be processed. When additional outputs remain, flow proceeds to step 230, wherein the next file to be output is retrieved. Following step 230, flow returns to step 222, wherein the current file is converted to the previously selected output format. Next, the user selects, at step 224, an operation/task for the current converted output. Processing, in accordance with method of FIG. 2, continues until at step 228 a determination is made that no additional outputs remain for which operations/tasks must be selected. Upon such a determination, flow proceeds to step 232, wherein each of the operations/tasks selected for each individual output are performed by the digital multifunction device 104.

Following step 232, flow proceeds to step 234, wherein a determination is made whether the user has indicated that the newly generated task is to be stored on the associated storage 114 of the digital multifunction device 104. When no such indication was made, flow proceeds to step 240, wherein a determination is made whether any additional inputs, i.e., originals, are to have tasks generated. When additional inputs remain, flow returns to step 202, wherein a determination is made whether the task for the next input is to be recorded. Operation in accordance with the present invention continues as set forth above for the next input. When no additional inputs remain at step 240, the operation terminates. When the user indicated at step 202 that the newly generated task was to be recorded, flow proceeds from step 234 to step 236, wherein the user is prompted to select a file name to be associated with the newly generated task. Following selection of the desired file name, flow proceeds to step 238, wherein the newly generated task is stored on the associated storage 114 of the digital multifunction device 104. It will be appreciated by those skilled in the art the in the instance wherein multiple new tasks have been generated, corresponding to the varied processing of multiple output sets, each individual task, which is capable of including one or more basic operations and one or more previously stored tasks, are stored in the associated storage 114, preferably under individual file names, thus requiring the user to input, at step 236, more than one file name, corresponding to the number of output sets and new tasks. Following storage of the newly generated task or tasks, flow proceeds to step 240, whereupon a determination is made whether another input remains to be processed. When no additional inputs remain, the operation terminates. When additional inputs remain to be processed, flow returns to step 202 for further operations in accordance with the method described above. The method whereby the user selects an operation or task for inclusion in the current task will better be understood in connection with the method outlined in FIG. 3.

Turning now to FIG. 3, there is shown a flowchart 300 illustrating a basic operation and previously stored task selection method in accordance with the present invention. Beginning at step 302, a determination is made whether the user has selected a task as a component of the task currently being generated. When the user has selected a task, flow proceeds to step 304, wherein the tasks previously stored on the storage 114 associated with the digital multifunction device 104 are retrieved. The retrieved tasks are then displayed to the user at step 306 for user selection of the desired task. The skilled artisan will appreciate that the display of the retrieved tasks at step 306 correlates to the user selection of a desired task or operation, as set forth at steps 218 and 224 of FIG. 2. The process then terminates following display of the retrieved tasks at step 306, until reinitiated by the digital multifunction device 104 following a determination that the user desires to add an additional operation and/or task at steps 220, 226, and 228 of FIG. 2.

Returning to FIG. 3, when it is determined at step 302 that a task has not been selected by the user, flow proceeds to step 308, wherein the user is prompted to select the layout associated with the file processing operation to be performed. It will be appreciated by those skilled in the art that the layout selected corresponds to, for example and without limitation, magazine sort, number-up, and the like. Following selection of the layout of the original file, flow proceeds to step 310, wherein the image processing options are selected. As will be appreciated by those skilled in the art, suitable image processing options include, but are not limited to, resizing the original, rotating the original, cropping the original, performing gamma-correction on the original, importing a previously recorded task, eliminating red-eye from images, sampling rates for audio files, sampling rates for video files, or the like. After selection of the desired image processing options, flow progresses to step 312, wherein the destination is selected. As used herein, the skilled artisan will appreciate that a destination selection of step 312 corresponds to selecting manner in which the output set will be output. Thus, a destination includes, but is not limited to, the raster image processing component of the digital multifunction device 104, a paper medium, a digital file, a portable storage device, a remote storage device, or any combination thereof.

After completing the selection of the destination, the method proceeds to step 314, whereupon the attachments/annotations are selected. As will be appreciated by those skilled in the art, suitable attachments/annotations include, but are not limited to, additional files, voice capture, video capture, handwritten input, such as a graphic tool, or any combination thereof. Next, the destination options are selected at step 316. Those skilled in the art will appreciate that suitable destination options, or finishing options, are capable of including, but need not be limited to, paper finishing options, such as stapling, hole-punching, tab insertion, and the like, output format, such as, PDF, TIFF, optical character recognition, TXT, DOC, and the like, and destination options, such as a mailbox number, a facsimile number, server name, a destination electronic mail address, an IP address, a storage location, or any combination thereof. Following step 316, the user has completed the step of selecting an operation or task in accordance with steps 218 and 224 of FIG. 2, and the operation of FIG. 3 terminates, until such time as the method of FIG. 2 returns to steps 218 or 224, whereupon FIG. 3 resumes operations at step 302.

In accordance with the present invention, the following example illustrates one embodiment of the present invention. An original input, such as an electronic message, is received by a user comprising a plurality of attachments, a PDF file, a JPEG file, a WAV file, an AVI file, and a DOC file. The user requires that each of the received files be converted to an alternate digital format, whereupon each converted file is sent to a different destination. In accordance with the present invention, the user selects the desired output formats, i.e., the PDF file needs to be converted to a TXT file, the JPEG file requires conversion to a TIFF file, the WAV file must be converted to an MP3 format, the AVI file must be converted to a WMA file, and the DOC file must be converted to a WPD file. The digital multifunction device 104 is suitably adapted to perform such conversions in accordance with the user provided instructions. Next, the user is prompted for any tasks/operations to be performed on the converted files, such that the TXT file is sent to the file server 122 for storage, the TIFF file is sent to the client device 118, the MP3 file is stored on the digital multifunction device associated storage 114, the WMA is to be sent, with a recorded attachment from the digital multifunction device 104 to a remote client (not shown), and the WPD file is printed by the digital multifunction device 105. Each of the operations associated with the converted files are thereby stored as a single task, which is capable of being implemented by a user every time an electronic message is received containing a PDF file, JPEG file, WAV file, AVI file, and DOC file as attachments. Furthermore, each set of operations corresponding to the individual attachments are capable of being stored as independent tasks, such that whenever the digital multifunction device 104 receives a PDF file from the associate user, it is automatically converted to a TXT file and sent to the file server 122 for storage. It will be appreciated by those skilled in the art that the foregoing example is illustrative of the method according to the present invention, and the skilled artisan will understand that other conversions, operations, and tasks are equally capable of being created and implemented, without departing from the scope of the present invention.

The invention extends to computer programs in the form of source code, object code, code intermediate sources and object code (such as in a partially compiled form), or in any other form suitable for use in the implementation of the invention. Computer programs are suitably standalone applications, software components, scripts or plug-ins to other applications. Computer programs embedding the invention are advantageously embodied on a carrier, being any entity or device capable of carrying the computer program: for example, a storage medium such as ROM or RAM, optical recording media such as CD-ROM or magnetic recording media such as floppy discs. The carrier is any transmissible carrier such as an electrical or optical signal conveyed by electrical or optical cable, or by radio or other means. Computer programs are suitably downloaded across the Internet from a server. Computer programs are also capable of being embedded in an integrated circuit. Any and all such embodiments containing code that will cause a computer to perform substantially the invention principles as described, will fall within the scope of the invention.

The foregoing description of a preferred embodiment of the invention has been presented for purposes of illustration and description. It is not intended to be exhaustive or to limit the invention to the precise form disclosed. Obvious modifications or variations are possible in light of the above teachings. The embodiment was chosen and described to provide the best illustration of the principles of the invention and its practical application to thereby enable one of ordinary skill in the art to use the invention in various embodiments and with various modifications as are suited to the particular use contemplated. All such modifications and variations are within the scope of the invention as determined by the appended claims when interpreted in accordance with the breadth to which they are fairly, legally and equitably entitled.

What is claimed:

1. A system for assembly of multiple format digital files comprising:
means adapted for selecting at least one digital input from a plurality thereof;
means adapted for receiving data representative of a plurality of selected output formats for the at least one digital input;
conversion means adapted for converting the at least one digital input into each of the plurality of selected output formats; and
output means adapted for outputting each converted digital input to an associated document output device.

2. The system for assembly of multiple format digital files of claim 1 wherein the at least one digital input includes at least one of an audio file, a video file, a text file, and an image file.

3. The system for assembly of multiple format digital files of claim 2 wherein the at least one digital input is received from at least one of a data storage, scanner, facsimile, microphone, video capture device, copier, and print stream.

4. The system for assembly of multiple format digital files of claim 3 further comprising:
storage means adapted for storing instruction data representative of a plurality of pre-selected electronic document conversions; and
means adapted for communicating instruction data to the conversion means so as to complete pre-selected conversions specified by the instruction data.

5. The system for assembly of multiple format digital files of claim 1 wherein:
the conversion means includes means adapted for converting at least one selected digital input into a plurality of different output formats; and
each of the plurality of different output formats is communicated, via the output means, to a distinct document output device.

6. A system for assembly of multiple format digital files comprising:
receiving means adapted for receiving input data representative of a first digital file in a first file format;
the receiving means further including means adapted for receiving input data representative of at least one second digital file in a file format distinct from the first file format;
conversion means adapted for converting each received digital file into at least one of a plurality of selected output formats; and
output means adapted for outputting each converted digital file to an associated document output device.

7. The system for assembly of multiple format digital files comprising of claim 6 further comprising:
means adapted for receiving selection data representative of a plurality of selected output formats for the at least one digital input; and
wherein the conversion means includes means adapted for converting each received digital file to an output format in accordance with the selection data.

8. The system for assembly of multiple format digital files of claim 7 wherein the at least one of the first digital file format and the second digital file format includes at least one of an audio file, a video file, a text file, and an image file.

9. The system for assembly of multiple format digital files of claim 8 wherein the at least one of the first digital file and the second digital file is received from at least one of a data storage, scanner, facsimile, microphone, video capture device, copier, and print stream.

10. The system for assembly of multiple format digital files of claim 9 further comprising:
storage means adapted for storing instruction data representative of a plurality of pre-selected output formats conversions; and
means adapted for communicating instruction data to the conversion means so as to complete pre-selected conversions specified by the instruction data.

11. A method for assembly of multiple format digital files comprising the steps of:
selecting at least one digital input from a plurality thereof;
receiving data representative of a plurality of selected output formats for the at least one digital input;
converting the at least one digital input into each of the plurality of selected output formats; and
outputting each converted digital input to an associated document output device.

12. The method for assembly of multiple format digital files of claim 11 wherein the at least one digital input includes at least one of an audio file, a video file, a text file, and an image file.

13. The method for assembly of multiple format digital files of claim 12 wherein the at least one digital input is received from at least one of a data storage, scanner, facsimile, microphone, video capture device, copier, and print stream.

14. The method for assembly of multiple format digital files of claim 13 further comprising the steps of:
storing instruction data representative of a plurality of pre-selected electronic document conversions; and
communicating instruction data to the conversion means so as to complete pre-selected conversions specified by the instruction data.

15. The method for assembly of multiple format digital files of claim 1 further comprising the steps of:
converting at least one selected digital input into a plurality of different output formats; and
communicating each of the plurality of different output formats, via the output means, to a distinct document output device.

16. A method for assembly of multiple format digital files comprising the:
receiving input data representative of a first digital file in a first file format;
receiving input data representative of at least one second digital file in a file format distinct from the first file format;
converting each received digital file into at least one of a plurality of selected output formats; and
outputting each converted digital file to an associated document output device.

17. The method for assembly of multiple format digital files comprising of claim 16 further comprising the steps of:
receiving selection data representative of a plurality of selected output formats for the at least one digital input; and
converting each received digital file to an output format in accordance with the selection data.

18. The method for assembly of multiple format digital files of claim 17 wherein the at least one of the first digital file format and the second digital file format includes at least one of an audio file, a video file, a text file, and an image file.

19. The method for assembly of multiple format digital files of claim 18 wherein the at least one of the first digital file and the second digital file is received from at least one of a data storage, scanner, facsimile, microphone, video capture device, copier, and print stream.

20. The system for assembly of multiple format digital files of claim 19 further comprising the steps of:
storing instruction data representative of a plurality of pre-selected output formats conversions; and
communicating instruction data to the conversion means so as to complete pre-selected conversions specified by the instruction data.

21. A computer-readable medium of instructions having computer-readable instructions stored thereon for assembly of multiple format digital files comprising:
instructions for selecting at least one digital input from a plurality thereof;
instructions for receiving data representative of a plurality of selected output formats for the at least one digital input;
instructions for converting the at least one digital input into each of the plurality of selected output formats; and
instructions for outputting each converted digital input to an associated document output device.

22. A computer-readable medium of instructions having computer-readable instructions stored thereon for assembly of multiple format digital files comprising the:
instructions for receiving input data representative of a first digital file in a first file format;
instructions for receiving input data representative of at least one second digital file in a file format distinct from the first file format;
instructions for converting each received digital file into at least one of a plurality of selected output formats; and
instructions for outputting each converted digital file to an associated document output device.

23. A computer-implemented method for assembly of multiple format digital files comprising the steps of:
selecting at least one digital input from a plurality thereof;
receiving data representative of a plurality of selected output formats for the at least one digital input;
converting the at least one digital input into each of the plurality of selected output formats; and
outputting each converted digital input to an associated document output device.

24. A computer-implemented method for assembly of multiple format digital files comprising the:
receiving input data representative of a first digital file in a first file format;
receiving input data representative of at least one second digital file in a file format distinct from the first file format;
converting each received digital file into at least one of a plurality of selected output formats; and
outputting each converted digital file to an associated document output device.
